(19) United States
(12) Patent Application Publication
(10) Pub. No.: US 2017/0057755 A1
(43) Pub. Date: Mar. 2, 2017

(54) DEVICE COMPRISING A TURNING UNIT FOR TURNING A WORKPIECE AND MACHINING DEVICE

(71) Applicant: LISSMAC MASCHINENBAU GMBH, Bad Wurzach (DE)

(72) Inventor: Stefan KRUMMENAUER, Bad Waldsee-Gaisbeuren (DE)

(73) Assignee: LISSMAC MASCHINENBAU GMBH, Bad Wurzach (DE)

(21) Appl. No.: 15/348,090

(22) Filed: Nov. 10, 2016

Related U.S. Application Data
(63) Continuation of application No. PCT/EP2015/075074, filed on Oct. 29, 2015.

(30) Foreign Application Priority Data
Nov. 4, 2014 (DE) 10 2014 116 017.7

(51) Int. Cl. B65G 47/252; B24B 27/00; B24B 41/00; B24B 7/06

(52) U.S. Cl. CPC B65G 47/252; B24B 7/06; B24B 27/0023; B24B 27/0069; B24B 27/0076; B24B 41/005

(57) ABSTRACT

A device including a turning unit for turning a workpiece, the turning unit including a drivably movable turning body with a contact member that is movable along a curved movement path with the movement of the turning body, as well as a guide arrangement for guiding the workpiece during the turning operation which is positioned adjacent the contact member along the movement path such that during a turning operation, the contact member is movable into pressing contact with the workpiece in such a manner that during the turning operation, the workpiece is entrainable along the movement path.

### CROSS REFERENCE TO RELATED APPLICATIONS

This application is a continuation of International Application No. PCT/EP2015/075074 filed Oct. 29, 2015, which designated the United States, and claims the benefit under 35 USC §119(a)-(d) of German Application No. 10 2014 116 017.7 filed Nov. 4, 2014, the entireties of which are incorporated herein by reference.

### FIELD OF THE INVENTION

The present invention relates to a device comprising a turning unit for turning a workpiece and a machining device.

### BACKGROUND OF THE INVENTION

The degree of automation for machining workpieces such as, for example, metal plate-like workpieces as a result of, for example, grinding is ever increasing in modern installations. As a rule, all the surfaces of the workpieces, in particular, flat top and bottom surfaces, have to be machined in a same standard manner and consequently have to be accessible. Up to now, it has not been possible to turn workpieces with different developments with a maximum edge length of up to circa 280 millimeters in a reliable manner without the supervision of a person. Consequently, after a first machining step for machining a top surface of a workpiece, it is necessary to have a person on site so that they can ensure that the workpieces are turned for a subsequent machining of the bottom surface of the workpiece. This is uneconomical or labor-intensive and disadvantageous with regard to an increase in a degree of automation of the machining of the workpieces.

### SUMMARY OF THE INVENTION

It is the object of the present invention to design the machining of surfaces of workpieces, such as, for example, plate-shaped metal workpieces, so as to be more effective. In particular, the degree of automation of the complete machining of the surfaces of workpieces with an edge length of between circa 20 and circa 280 millimeters is to be increased.

The present invention proceeds from a device comprising a turning unit for turning a workpiece.

Up to now, the approach followed, for example, is to move the workpiece to a shoulder that is free below such that, supported by the own weight of the workpiece, the workpiece is forcibly tipped, with the aim of the workpiece, turned, coming to rest on a surface which is located further down than the shoulder. The turning, however, only works when the conditions prevailing are always reproducible or the same. Success depends, in particular, on the speed of movement of the workpiece when it approaches the shoulder, on the form, the dimensions, the alignment, the center of gravity and on the overall weight or the material of the workpiece.

The core of the present invention consists in that the turning unit includes a drivably movable turning body with a contact member that is movable along a curved movement path with the movement of the turning body, as well as a guide arrangement for guiding the workpiece during the turning operation which is positioned adjacent the contact member along the movement path such that during a turning operation, the contact member is movable into pressing contact with the workpiece in such a manner that during the turning operation the workpiece is entrainable along the movement path. Consequently, corresponding workpieces are able to be turned reliably and in a completely automated manner without exception.

In an advantageous manner, the turning unit is realized to turn plate-shaped metal workpieces.

In an advantageous manner, the movement of the workpiece is guided over the entire turning operation by means of a main side in contact with the contact member. This is achieved according to the present invention without exception for all forms and dimensions of the workpiece which are within pre-determinable design limits of the turning unit according to the present invention. There is no tipping about a point or a line with a falling movement in free space, which results in non-defined movement states.

With the interaction between the contact member and the workpiece, on the one hand, and between the guide arrangement and the workpiece, on the other hand, over part of the movement path or, in particular, over the entire movement path when turning, the workpiece is always moved in a defined manner and consequently cannot take up an unwanted spatial alignment. During the turning operation, the workpiece remains uninterruptedly and advantageously in contact with the contact member over the entire relevant main side or top surface, in particular, over the entire surface which forms a bottom surface of the workpiece prior to the turning operation. As a rule, the contact member is not in abutment over the entire surface of the relevant main side of the workpiece, but partially over a plurality of evenly distributed points or regions, for example, according to many specific, planar and/or linear contact points.

The ends of the contact member, by means of which, as a rule, the touching contact with the workpiece can be set up, are located, in the non-loaded basic state or without workpiece contact, advantageously inside a closed or curved surface, e.g. a surface that is formed regularly in a geometric manner, in particular, inside a cylindrical strip-shaped lateral surface of the turning body. The movement path for the entrained workpiece, along which the workpiece is entrained during the turning operation, is also determined by the development of the surface when the turning body moves. The contact member serves for receiving and holding the workpiece at the turning body.

With the present invention, a planar main side of the workpiece can be aligned turned by 180 angular degrees about a horizontal axis, for example, from a horizontal alignment of the main side surfaces facing upward, into a horizontal alignment facing downward. In reverse, a main side of the workpiece which is directed downward prior to the turning operation is turned upward such that it forms the top surface and is accessible for subsequent processing.

The basic form of the workpiece is frequently four-cornered or has multiple corners and/or has a curved edge development. As a rule, the material thickness of the workpiece between the planar main sides is constant. Narrow sides, which are realized narrow according to the thickness dimension and which stand regularly at right angles to the main sides, are formed between the planar main sides or between the top and bottom surface over the thickness of the workpiece.

A defined movement of the workpiece takes place with the turning unit, the workpiece carrying out a movement in the vertical direction, in particular, downward, superimposed with respect to the turning movement. After the end of the turning movement of the workpiece, the workpiece is advantageously situated completely turned and offset vertically downward in a perpendicular manner compared to the state directly prior to the start of the turning operation or at the start of the entrainment movement of the workpiece by the turning unit.

The device or the turning unit can be present, in particular, between two units of a machining device for machining surfaces. In this case, the workpiece can be conveyed from a position where the workpiece is received to a position where the workpiece is removed, between which positions, with the run-through the machining devices, surface regions which are accessible from above or the top surface and then after the turning operation with the turning device according to the present invention, the surface regions that have been turned upward, are machined, as a result of which all the surfaces of the workpiece are fed in an automated manner for machining.

The guide arrangement is, in particular, adjacent or located opposite the contact member, spaced apart from them by a spacing which is within the range of a thickness of the workpieces to be turned. Workpiece movements to the outside or away from the turning body, which have to be considered, for example, on account of weight forces acting on the workpiece when it is turned, can be avoided or intercepted by way of the guide arrangement. In particular, the guide arrangement is at a constant or almost constant spacing to the contact member over the length of the curved movement path. In particular, the guide arrangement is present at a radially outward spacing over at least almost the entire movement path of the workpiece entrained by the turning body.

The contact member is somewhat yielding in themselves and are coordinated in such a manner that it is possible to turn workpieces which comprise a thickness which is within a value range of up to a few centimeters, in particular, up to circa 20 millimeters.

During turning, the workpiece advantageously remains in pressing contact with the contact member over the entire turning operation.

The guide arrangement is realized, in particular, in a planar and also curved manner over the entire extension of the curved movement path. Consequently, on one side of the workpiece, the workpiece is entrained in a contacting manner by the turning body by means of the contacting member and, on the other side, the guide arrangement prevents the workpiece from deviating or tilting away from the contact member.

It is additionally advantageous that the turning unit is designed to turn a plate-like metal workpiece which comprises a width dimension and a length dimension which is within a range of between circa 20 mm and circa 280 mm and a thickness dimension within a range of circa 1 mm and circa 20 mm. Consequently, a useful or working dimension is provided with the device, for workpieces with a minimum dimension of between circa 20 mm by 20 mm by 1 mm and a maximum dimension of circa 280 mm by 280 mm by 20 mm, which refers to the length by the width by the thickness of the workpiece and to all intermediate dimensions.

Precisely in the case of the orders of magnitude of metal plate-like workpieces, it has not been possible to date to turn the workpieces reliably in an automated manner.

It is over and above this advantageous that the turning unit includes a cylindrical turning body which is rotatingly drivable about an axis. A very compact and reliable and nevertheless continuously operating turning arrangement can be realized with a cylindrical or roller-like turning body. The speed and where applicable also the direction of rotation can be adjusted by way of the associated drive unit for the rotation of the turning roller, for example, an electric motor. The cylindrical turning body advantageously comprises an inner cylindrical roller basic body with a cylinder surface, on the circumference of which the contact member is mounted so as to be directed outwardly or so as to protrude outwardly. The radially outer ends of the contact member forms an outside dimension or an outside diameter of the cylindrical turning body.

In an advantageous manner, the guide arrangement is movable in a driven manner. In particular, the guide arrangement is an arched surface element. The circulation speed of the guide arrangement is in particular variably adjustable by way of a drive means. In particular, the speed of the guide arrangement corresponds to the circulation speed on the outside of the roller-shape turning body. Consequently, relative movements between the workpiece and the guide arrangement can be avoided or kept to a minimum, as a result of which friction losses are advantageously minimized. The guide arrangement is realized at a constant spacing, in particular, along the curved movement path of the contact member. When a cylindrical turning body is present, the guide arrangement is advantageously present over approximately 180 angular degrees or over half the circumference on the outside circumference of the outside surface of the cylindrical turning unit. The guide arrangement is realized, in particular, between an upper inlet region on the roller in the circulating direction of the roller and a lower outlet region for the outlet of the turned workpiece. Accordingly, in the case of a turning roller with a cylindrical circumferential lateral surface which is formed by the contact member, the guide arrangement is realized in the form of a half-shell over half of the circumferential lateral surface of the turning roller.

In addition, it is advantageous that the guide arrangement includes a driven circulating belt element. In particular, the guide arrangement can be a continuously circulating belt or a belt which is guided in a closed manner in the form of a ring. Advantageously, the belt element is provided with a tensioning device, by way of which an optimum belt tension is able to be set up.

According to an advantageous variant of the present invention, the turning unit comprises a turning body which is rotatable about a rotational axis and is realized at the circumference with radially extending contact elements of the contact member. In particular, the contact elements are arranged in a uniform manner and are realized on the outside over the entire circumference and the entire width of the turning body like a roller. For example, the contact element can consist of different suitable materials and can comprise different forms or dimensions. In an advantageous manner, all the contact element on a turning body are identical to one another. However, a mixture of different contact elements on a turning body is not ruled out.

For different designs of turning bodies, the turning body is received on the turning device in a preferred manner so as to be exchangeable. For example, the contact elements can include a plurality of slender, thin planar elements of the same type such as, for example, bristle-like or lamella-like elements. The surfaces of the lamellae can be aligned, in particular, parallel or at an angle with respect to the rotational axis of the turning body.

In an advantageous manner, the contact member includes a plurality of elongated radiating elements. The radiating elements can be, for example, fiber-like, bristle-like or rod-like. From the first contact when the workpiece is received, the workpieces can be advantageously gripped, entrained and held by way of the radiating elements.

In particular, the elongated radiating elements are bristle-like radiating elements or contact bristles. In particular, all the radiating elements are realized in a uniform or homogeneous manner. The radiating elements are in particular deflectable, resilient or rigid so as to be self-resetting. Different plastics materials, metals or composite materials, in particular, are possible for this.

The exterior form of the radiating elements is, in particular, cylindrical with a diameter within the range of between less than one millimeter and circa 1 or 2 millimeters. Typical length dimensions of the radiating elements are, for example, approximately between 10 and 20 centimeters and more.

The distribution, the thickness or the overall number of radiating elements on a turning body depends on the design of the turning device or on the workpiece.

It is particularly advantageous, over and above this, that the radiating elements are inclined at an angle on the turning body with their longitudinal axes in the direction of movement of the turning body, preferably are present aligned by between circa 10 and 20 angular degrees, in particular, by about 15 angular degrees, relative to a radial direction. The radial direction is based on the rotational axis of the turning body or of the roller body. The 15° angle is based on a radially inside foot or a radially inside end of the radiating elements and is, in particular, advantageous as less expenditure of force is necessary at the turning unit for running in or receiving the workpiece which is moved closer to the turning body.

In particular, all the radiating elements are aligned correspondingly at a 15° angle. The radiating elements are advantageously deflectable or bendable at least with their front free ends.

It is additionally advantageous that the contact member includes a plurality of elongated radiating elements which are developed in a yielding manner. Consequently, a particularly effective clinging or adhering contact between the contact member or the radiating elements and the workpiece can be set up. In the case of workpieces which are provided with contours such as elevations and/or indentations, the radiating elements consequently also move into touching or pressing contact in regions that are marked by contours such that even such workpieces are able to be securely entrained, held and moved along the movement path.

It is advantageous over and above this that the contact member includes a plurality of elongated radiating elements which include several bundles of radiating elements which are each formed from several radiating elements. The radiating bundles make possible a particularly effective holding contact at the workpiece and a specifically variable clinging to the surfaces of the workpiece. In particular, the bundles are all spaced apart from one another in the same manner. In particular, all the radiating element bundles on one turning body are formed from a same number of individual radiating elements.

The multiple radiating elements can be fixed, for example, inserted into corresponding holes in a cylindrical lateral surface of the basic body of the turning body.

However, it is also possible that the contact elements are formed from a plurality of elongated radiating elements which are not present in a bundled manner.

The present invention additionally relates to a machining device for the automated machining of surfaces of workpieces, preferably of plate-shaped metal workpieces, in particular, for rounding workpiece corners and/or for grinding workpiece surfaces, having a conveying arrangement for moving the workpiece along a machining path of the machining device and having machining units which are movable in a driven manner for acting on the workpiece. The machining device is, in particular, a rounding and/or a grinding device for grinding the workpieces with abrasive grinding bodies. These types of devices are required, for example, after a welding or laser-cutting process on plate-shaped metal workpieces to remove burrs and dross and for rounding edges before the workpieces are processed further, for example lacquered.

The essential aspect of the machining device according to the present invention consists in that a device as explained above is present between a top surface or a first machining unit for the automated machining of a first main side of the workpiece and a second machining unit for the automated machining of a bottom surface or a second main side of the workpiece. Consequently, the all-round surface machining of metal workpieces can be achieved in a fully automated and continuous manner, in particular, in the case of flat plate-shaped workpieces with a maximum dimension of 280 by 280 by 20 mm, length by width by thickness.

### BRIEF DESCRIPTION OF THE DRAWINGS

Further features and advantages of the present invention are explained in more detail by way of an exemplary embodiment of the present invention represented in schematic form in the figures.

FIG. 1 shows a perspective partial view of a machining device according to the present invention for the automated machining of a metal workpiece;

FIG. 2 shows a cutout from the arrangement from FIG. 1 from the side omitting individual components of the device;

FIG. 2a shows an enlarged cutout according to the circular region A from FIG. 2; and

FIG. 3 shows a turning device according to the present invention according to the arrangement from FIG. 1, a housing portion being realized in a transparent manner.

### DETAILED DESCRIPTION OF THE INVENTION

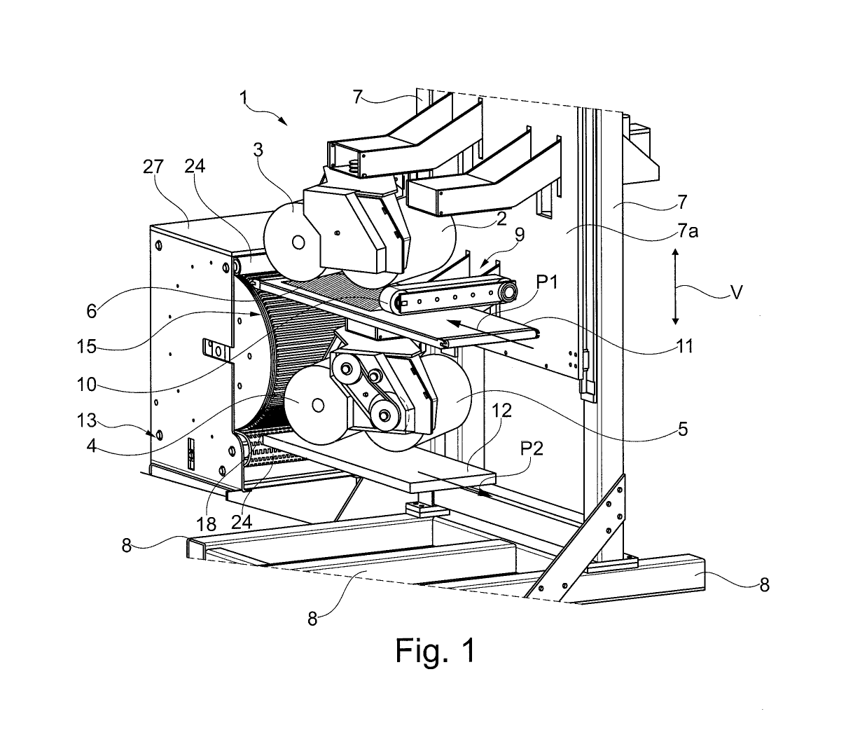

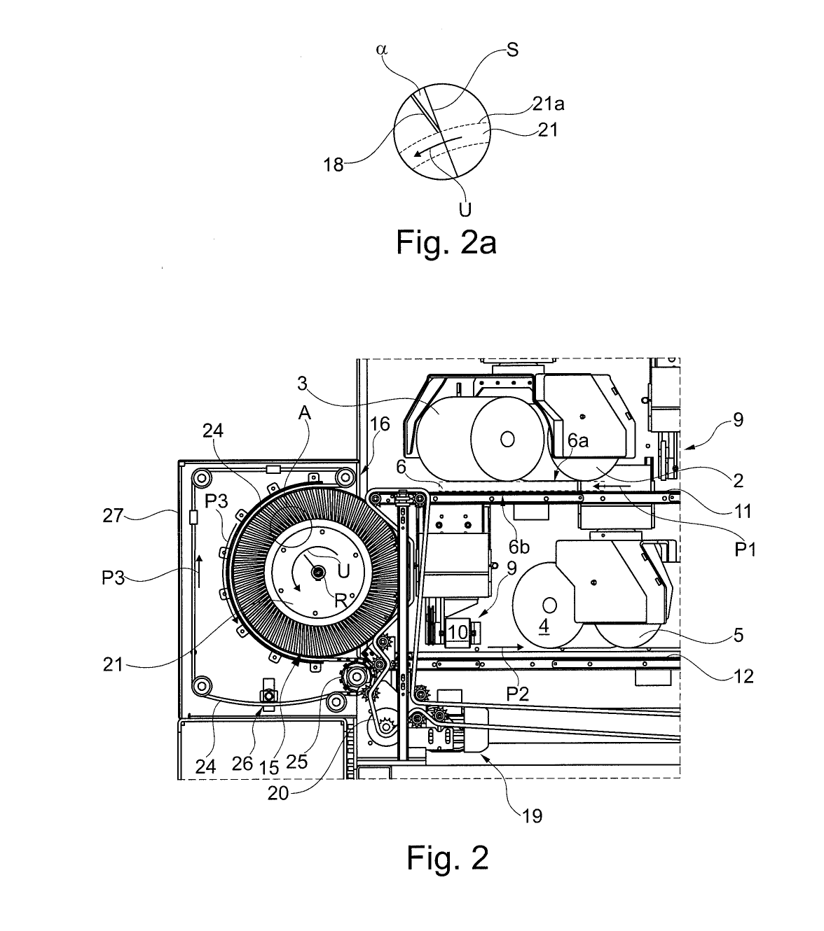

FIG. 1 shows a highly schematic representation in perspective of a cutout from a machining device 1 according to the present invention which is realized as an edge-rounding device and is designed for continuous operation for the automated machining of a metal workpiece 6. The machining device 1 is suitable, in particular, for machining plate-like flat profiles produced, for example, from a steel material with dimensions within the range of between circa 20×20×1 millimeters and circa 200×200×20 millimeters (length×width×height or thickness). The workpieces can be, for example, heavy plates which, for example, after a welding, cutting and separating or laser procedure, comprise sharp-edged surface and edge developments which have to be removed for further processing of the workpiece, such as lacquering, this being effected by means of material-removing machining as a result of automated machine-grinding of the surfaces or a rounding-off or rounding of the corners of the workpiece 6. As all the surface regions or edge regions on the workpiece 6 have to be fully machined, it is necessary to turn the workpiece 6 once the first main side 6a (see FIG. 2) has been machined so that the surface regions concealed during the first machining step by the workpiece 6 being supported on a contact surface or a second oppositely situated main side 6b on the workpiece are also accessible or free for surface machining. For turning the workpiece 6, the machining device 1 includes a turning device 13 according to the present invention with a turning unit 14.

Above an upper circulating feed belt 11 which is present for conveying the workpieces, the machining device 1 comprises two rotating roller-like grinding elements 2 and 3 and above a lower circulating feed belt 12 which is present for conveying workpieces it comprises two rotating roller-like grinding elements 4 and 5. The grinding elements 2 and 3, which are offset parallel to one another, are adjustable together about a vertical axis parallel, at an angle or transversely relative to the running direction of the feed belt 11, according to the circulating direction thereof, for a desired position of the grinding elements 2 and 3 relative to the feed belt 11. In a corresponding manner, the grinding elements 4 and 5 are adjustable relative to the feed belt 12. In FIG. 1 the grinding elements 2 and 3 or 4 and 5 are at an angle with respect to the running direction of the respective feed belt 11 or 12.

The machining of the workpiece 6 with the grinding elements 2 and 3 or 4 and 5 is effected along the feed path of the workpiece 6 on the feed belts 11 and 12 during the conveying movement of the workpiece 6, the workpiece 6 being moved in the conveying direction P1 resting on the upper feed belt 11 and in the conveying direction P2 resting on the lower feed belt 12. The rotatable grinding elements 2 to 5, which are driven in each case in a rotating manner about a horizontal axis, are all realized, in particular, in an identical manner, for example, in each case as an abrasive mop device for rounding edges.

In each case a cross machining unit 9 with a circulating grinding belt 10, which is driven transversely with respect to the conveying direction P1 or P2, is present spaced somewhat in the conveying direction P1 in front of the grinding elements 2 and 3 and in the conveying direction P2 in front of the grinding elements 4 and 5. The cross machining units 9 serve for removing coarse protrusions or burrs on the workpiece 6.

The machining device 1 includes a frame with two vertical parallel struts 7, between which a wall part 7a extends. Three horizontally aligned feet struts 8, which are cross-connected together and by means of which the machining device 1 is able to be installed on a floor area, connect to the struts 7 at the bottom.

An electric motor serves as the driving means 19 for the feed belts 11, and 12 of the machining device 1, the electric motor drives a drive belt 20, which is guided about several rollers, in a circulating manner and the drive belt, in turn, drives the feed belts 11 and 12 and also a circulating guide belt 24, which is explained again further below.

The two cross-machining units 9 and also the two upper grinding elements 2, 3 and the two lower grinding elements 4, 5 are in each case variably adjustable in the vertical direction V on the machining device 1 but are fixedly adjustable for the machining operation in order to match, in particular, a grinding depth of the grinding elements 2 to 5 on the surfaces of the workpiece 6, which depends on the material thickness and form or contour of the workpiece 6.

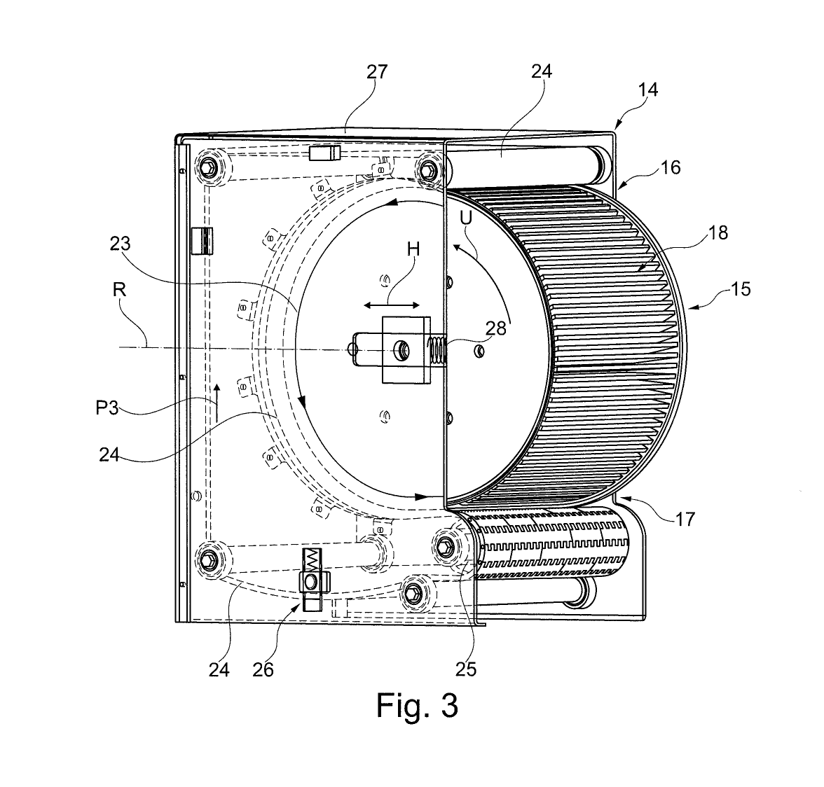

So that the workpiece 6 on the feed belt 11, on which it experiences top-side machining by way of the cross-machining unit 9 and the grinding elements 2 and 3, is also able to be machined on the bottom surface, the turning device 13 according to the present invention is provided with the turning unit 14. The turning unit 14 includes a turning body which is realized as a motor-driven turning roller 15 which rotates about the axis R in the circulating direction U (see FIG. 3). The turning device 13 is present between the upper feed belt 11 and the lower feed belt 12 in a vertical space between the vertically offset feed belts 11 and 12.

The turning device 13 receives the workpiece 6 from the feed belt 11 by way of the turning roller 15 in an higher circumferential inlet region 16 of the turning roller 15 on the rear end of the feed belt 11 in the direction of movement P1.

As a result of rotating the turning roller 15 in the direction U, the workpiece 6 is entrained downward along a semi-circular movement path 23 on the outside circumference of the turning roller 15, the workpiece 6 passing into a lower outlet region 17 and being turned by 180 angular degrees with reference to a horizontal axis or to the state on the feed belt 11 and passing to the lower feed belt 12 which moves in the conveying direction P2. The turned workpiece 6, resting on the feed belt 12, is first of all guided past the lower cross-machining device 9 and is machined by the device and then past the lower rotating grinding elements 4, 5 for extensive surface treatment, as a result of which the surfaces not yet machined up to now of the workpiece 6 are completely machined after passing beneath the grinding elements 4, 5.

According to the highly schematized representation, the turning roller 15 is provided with a plurality of contact members that are realized here as an example as same-type contact lamellae 18. As an alternative to the contact lamellae 18 which are aligned transversely with respect to the circulating direction U, the turning roller 15 can be provided with other contact members, in particular, with thin elongated radiating elements such as contact bristles which are present advantageously as a plurality of bristle bundles, each with several individual bristles assembled together to form the bristle bundle. The contact lamellae 18 or the contact bristles are present distributed evenly or regularly over the entire circumferential and axial outside surface of a roller body 21 of the turning roller 15.

The outside circumference of the turning roller 15 is adapted to the vertical spacing between the feed belts 11 and 12, the turning roller 15 comprising the cylindrical roller body 21 on the inside, the central cylinder axis of which coincides with the rotational axis R for the pivot bearing arrangement of the rotatingly drivable turning roller 15.

As illustrated, in particular, in FIGS. 2 and 2a, on the outside of the roller body 21 over the entire cylindrical lateral surface 21a thereof, the contact lamellae 18 are present aligned in the same manner. With reference to the respective feet of the contact lamellae 18 on the lateral surface 21a, the contact lamellae 18 are inclined by the angle α of circa 15 angular degrees in the direction of the circulating direction U of the turning roller 15 (see FIG. 2a) as opposed to the alignment which is precisely radial with respect to the axis R according to the line S. This reduces the torque to be applied by the turning roller 15 at the moment of receiving the workpiece 6 in the inlet region 16 as compared to a precisely radial alignment of the contact lamellae 18. FIG. 2a shows just one contact lamella 18 singled-out for better clarity of representation.

Correspondingly, in the case of an alternative realization of the turning roller 15 with bristles, the contact bristles or bristle bundles of the turning roller 19 are advantageously also aligned inclined by circa 15 angular degrees in the rotating direction U with respect to the radial alignment.

The aligned contact lamellae 18 make it possible to entrain the workpiece 6 in an optimum manner from the end of the upper feed belt 11, the contact member pressing from below against the workpiece 6 and fixing the workpiece. The flexible, deflectable or rigid contact member moves into contact with the workpiece 6 in the inlet region 16 and hold the workpiece during the movement along the curved movement path 23 from the region 16 to the region 17. In this case, the workpiece 6 sinks somewhat, where applicable, into the contact member, which favors the positioning and holding of the workpiece 6. As a result, the workpiece 6 remains in a defined position during the turning operation.

So that the workpiece 6 is not able to be tilted outward or downward when the turning roller 15 is rotated along the downwardly inclined movement path 23, the guide arrangement, which is developed as a circulating guide belt 24 and extends from the inlet region 16 as far as the outlet region 17 over half the circumference of the turning roller 15 on the side remote from the inlet region 16 and the outlet region 17 or the feed belts 11, 12, is present along the movement path 23, on the outside opposite the free ends of the contact member or of the contact lamellae 18.

The guide belt 24 which is driven circulating in the direction P3 is guided along several rollers which include a driven drive roller 25 which is driven, for example, by the driving means 19.

In order to enable a small deflecting movement of the turning roller 15 in the horizontal direction H (see FIG. 3) relative to a fixed housing 27 of the turning unit 14, the turning roller 15 is resiliently received on the housing 27 in the region of its rotational axis R by means of a pre-tensioned spring 28. The safety aspect, if, for example, a user inserts too large a workpiece which would jam between the turning roller 15 and the surrounding guide belt 24, is effected by way of a displacement of the displaceably mounted turning roller 15 by a predefined value, the machining device 1 being shut down with the information “workpiece too large”.

In addition, a tensioning device 26 is provided for adjusting a belt tension of the guide belt 24.

In an advantageous manner, the unit with the grinding elements 2, 3, the unit with the grinding elements 4, 5 and in each case the cross-machining units 9 are adjustable in the vertical direction V relative to the wall part 7a.

In addition, it is advantageous when the surrounding conveyor belt comprises a tensioning device so that the conveyor belt operates at a constant tension.

It is also advantageous when the turning device 13 is developed so as to be able to be pivoted away so that the remaining part of the machining device 1 is able to operate at least on a plane without turning work in order, for example, still to be able to machine larger workpieces which are outside the design of the turning device 13.

### LIST OF REFERENCES

1 Machining device
2 Grinding element
3 Grinding element
4 Grinding element
5 Grinding element
6 Workpiece
6a, 6b Main side
7 Feed belt
7a Wall part
8 Strut
9 Foot strut
10 Cross-machining unit
11 Grinding belt
12 Feed belt
13 Turning device
14 Turning unit
15 Turning roller
16 Inlet region
17 Outlet region
18 Contact lamellae
19 Driving means
20 Drive belt
21 Roller body
21a Lateral surface
22 Spring element
23 Movement path
24 Guide belt
25 Drive roller
26 Tensioning device
27 Housing
28 Spring

1. A device comprising a turning unit for turning a workpiece, wherein the turning unit includes a drivably movable turning body with a contact member that is movable along a curved movement path with the movement of the turning body, as well as a guide arrangement for guiding the workpiece during the turning operation which is positioned adjacent the contact member along the movement path such that during a turning operation, the contact member is movable into pressing contact with the workpiece in such a manner that during the turning operation the workpiece is entrainable along the movement path.

2. The device as claimed in claim 1, wherein the turning unit is realized to turn plate-shaped metal workpieces.

3. The device as claimed in claim 1, wherein the turning unit is designed to turn a plate-like metal workpiece which comprises a width dimension and a length dimension which is within a range of between about 20 millimeters and about 280 millimeters and a thickness dimension within a range of about one millimeter and about 20 millimeters.

4. The device as claimed in claim 1, wherein the turning unit includes a cylindrical turning body which is rotatingly drivable about an axis.

5. The device as claimed in claim 1, wherein the guide arrangement is movable in a driven manner.

6. The device as claimed in claim 1, wherein the guide arrangement includes a belt element which circulates in a driven manner.

7. The device as claimed in claim 1, wherein the turning unit comprises a turning body which is rotatable about a rotational axis and is realized at the circumference with radially extending contact elements of the contact member.

8. The device as claimed in claim 1, wherein the contact member includes a plurality of elongated radiating elements.

9. The device as claimed in claim 8, wherein the radiating elements are inclined at an angle on the turning body with their longitudinal axes in the direction of movement of the turning body.

10. The device as claimed in claim 1, wherein the contact member includes a plurality of elongated radiating elements which are developed in a yielding manner.

11. The device as claimed in claim 1, wherein the contact member includes a plurality of elongated radiating elements which include several bundles of radiating elements which are each formed from several radiating elements.

12. The device as claimed in claim 1, wherein the contact member is formed from a plurality of elongated radiating elements which are not present in a bundled manner.

13. A machining device for the automated machining of surfaces of workpieces, having a conveying arrangement for moving the workpiece along a machining path of the machining device and having machining units, which are movable in a driven manner, for acting upon the workpiece, wherein a device as claimed in claim 1 is present between a first machining unit for the automated machining of a top surface of the workpiece and a second machining unit for the automated machining of a bottom surface of the workpiece.

14. The device as claimed in claim 9, wherein the radiating elements are inclined at an angle of about 15 angular degrees relative to a radial direction.

15. The machining device of claim 13, wherein the workpieces are plate-shaped metal workpieces and the machining rounds edges of the workpieces and/or grinds surfaces of the workpieces.
